(19) United States
(12) Patent Application Publication
(10) Pub. No.: US 2007/0024607 A1
(43) Pub. Date: Feb. 1, 2007

(54) Monitor and extended display identification data (EDID) access method thereof

(75) Inventor: Min-Jye Chen, Miaoli City (TW)

Correspondence Address: RABIN & Berdo, PC, 1101 14TH STREET, NW, SUITE 500, WASHINGTON, DC, 20005, US

(73) Assignee: BenQ Corporation

(21) Appl. No.: 11/493,593

(22) Filed: Jul. 27, 2006

(30) Foreign Application Priority Data
Jul. 27, 2005 (TW) 94125468

(51) Int. Cl. G09G 5/00

(52) U.S. Cl. 345/204

(57) ABSTRACT

A monitor includes a memory and a radio frequency identification (RFID) control unit. The memory is for storing extended display identification data (EDID). The RFID control unit, coupled to the memory, is for sending the EDID stored in the memory to the RFID reader and storing the EDID sent from the RFID reader into the memory. The EDID access method includes performing an EDID reading procedure including sending out a read data signal to the RFID control unit by using the RFID reader, and packing the EDID stored in the memory into a RFID-format signal and outputting the RFID-format signal to the RFID reader; and performing an EDID writing procedure including sending a write data signal having the EDID to the RFID control unit by using the RFID reader, and writing the EDID of the write data signal into the memory by using the RFID control unit.

This application claims the benefit of Taiwan application Serial No. 94125468, filed Jul. 27, 2005, the subject matter of which is incorporated herein by reference.

### BACKGROUND OF THE INVENTION

1. Field of the Invention

The invention relates in general to a monitor and extended display identification data (EDID) access method thereof, and more particularly to a monitor in which EDID are accessed by using radio frequency identification (RFID) and EDID access method thereof.

2. Description of the Related Art

FIG. 1 is a structure diagram of a conventional monitor. Referring to FIG. 1, the monitor 100 includes a video graphic array (VGA) connector 110 and an electrically erasable programmable read only memory (EEPROM) 120. The EEPROM 120 is a plug-in component for storing EDID. The VGA connector 110 is coupled to the EEPROM 120 via serial clock (SCL) and serial data (SDA) transmission lines of an inter-integrated circuit (I2C) bus 130. Besides, the power pin VCC of the EEPROM 120 is inputted by a voltage 5V from a computer host.

Traditionally, a host display card (not shown in the figure), is connected to the VGA connector 110 via a VGA cable and transmits EDID to the EEPROM 120 via the I2C bus 130.

In addition, FIG. 2 shows a structure diagram of another conventional monitor. Referring to FIG. 2, the monitor 200 includes a VGA connector 210, an EEPROM 220, and a micro-processing unit (MCU) 230. The EEPROM 220 is an embedded component for storing EDID and monitor data Dm. The VGA connector 210 is coupled to the MCU 230 via SCL and SDA transmission lines of an I2C bus 240 while the MCU 230 is coupled to the EEPROM 220 via the I2C bus 250. The power pin VCC of the EEPROM 220 is inputted by a voltage 5V from a computer host.

Similarly, a host display card (not shown in the figure) is coupled to the VGA connector 210 via a VGA cable, transmits EDID to the MCU 230 via the I2C bus 240, and then writes the EDID into the EEPROM 220 via the I2C bus 250. Or EDID are read from the EEPROM 220, transmitted to the MCU 230 via the I2C bus 250 and then sent to the VGA connector 210 for output via the I2C bus 240.

However, due to instability of the VGA cable mentioned above, accessing EDID by the VGA cable fails very easily. Furthermore, coupling VGA signal line to the monitor requires more labors, thereby reducing production and serving efficiency and increasing production cost.

### SUMMARY OF THE INVENTION

It is therefore an object of the invention to provide a monitor and EDID access method thereof. EDID can be read or written on the monitor by using a RFID reader or conventionally though a VGA connector. Therefore, not only the EDID transmission quality can be maintained at a good level, the labor requirement on production, serving and quality control can be reduced, but also the elasticity of reading and writing EDID can be improved.

The invention achieves the above-identified object by providing a monitor for a RFID to access EDID therein. The monitor includes a memory and a RFID control unit. The memory is for storing the EDID. The RFID control unit, coupled to the memory, is for sending the EDID stored in the memory to the RFID reader and storing the EDID sent from the RFID reader into the memory.

The invention achieves the above-identified object by providing an EDID access method, for a RFID reader to access the EDID on a monitor. The monitor includes a RFID control unit and a memory, and the memory is for storing the EDID. The method includes steps of performing an EDID reading procedure comprising sending out a read data signal to the RFID control unit by using the RFID reader; and packing the EDID stored in the memory into a RFID-format signal and outputting the RFID-format signal to the RFID reader; and performing an EDID writing procedure comprising sending a write data signal having the EDID to the RFID control unit by using the RFID reader; and writing the EDID of the write data signal into the memory by using the RFID control unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a structure diagram of a conventional monitor.

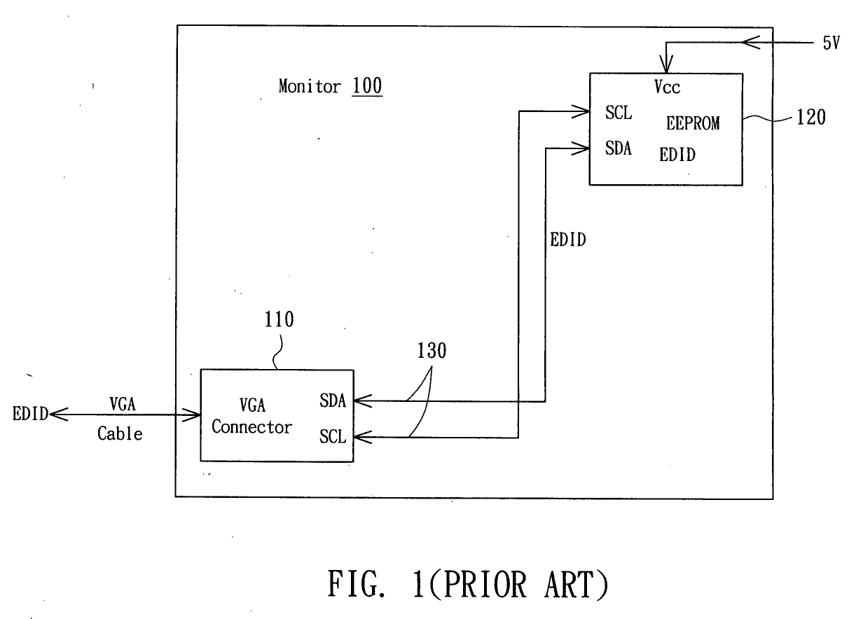

FIG. 2 is a structure diagram of another conventional monitor.

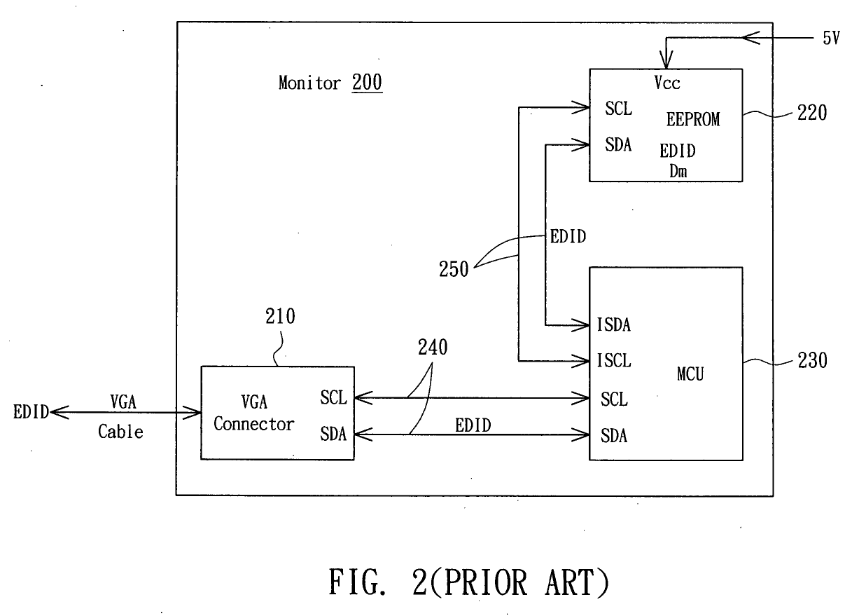

FIG. 3A is a structure diagram of a monitor according to a preferred embodiment of the invention.

FIG. 3B is a structure diagram of the monitor including a VGA connector coupled to a plug-in EEPROM according to the preferred embodiment of the invention.

FIG. 3C is a structure diagram of the monitor including a VGA connector coupled to an embedded EEPROM according to the preferred embodiment of the invention.

FIG. 4 is a flow chart of an EDID access method according to the preferred embodiment of the invention.

### DETAILED DESCRIPTION OF THE INVENTION

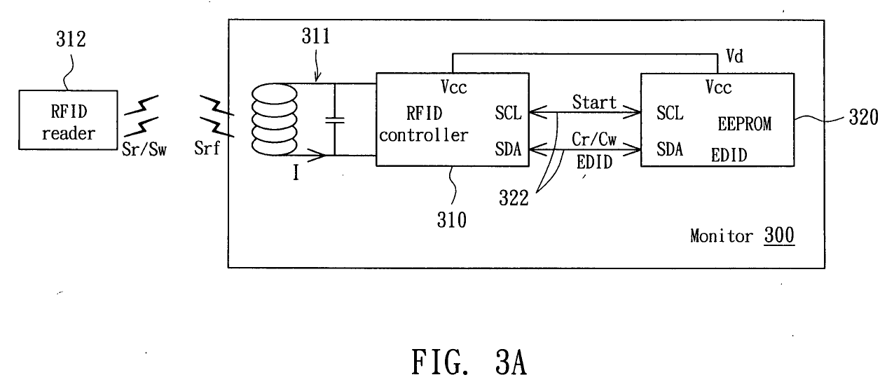

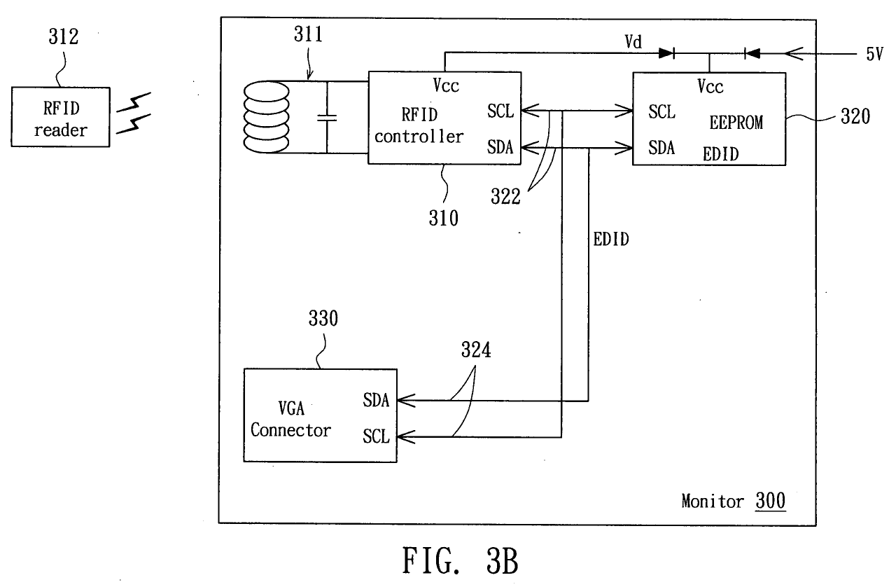

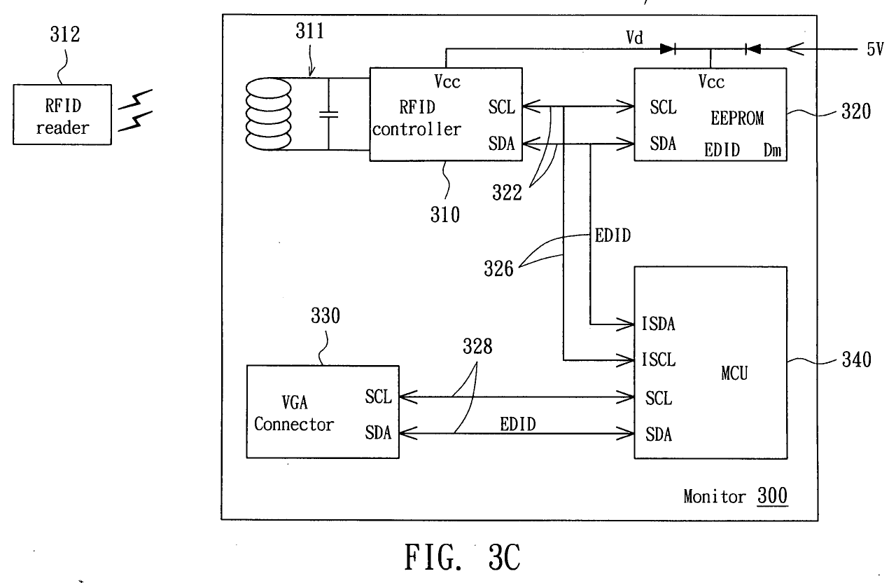

Referring to FIG. 3A, a structure diagram of a monitor according to a preferred embodiment of the invention is shown. The monitor 300 is used for a RFID reader 312 to read and write EDID therein. The monitor 300 includes a RFID controller 310, an antenna 311 and an EEPROM 320. The EEPROM 320 is for storing the EDID. The RFID controller 310 is coupled to the EEPORM 320 for transmitting the EDID from the EEPROM 320 to the RFID reader 312 via the antenna 311 and stores the EDID inputted from the RFID reader 312 to the EEPROM 320 via the antenna 311.

The antenna 311 is for receiving RFID-format signals outputted from the RFID reader 312, including a read data signal Sr and a write data signal Sw. The antenna 311 generates an induced current I for driving the RFID controller 310 as receiving the read data signal or write data signal Sr or Sw. The power pin Vcc of the RFID controller 310 is coupled to the power pin Vcc of the EEPROM 320. The driven RFID controller 310 outputs a driving voltage Vd (about 1.6V˜3V) to drive the EEPROM 320 via the power pin Vcc thereof.

Moreover, the RFID controller 310 outputs a start signal Start and a read or write data command Cr or Cw to the EEPROM 320 respectively through the SCL line and the SDA line of the I2C bus 322. Therefore, the RFID controller 310 can read EDID from or write EDID into the EEPROM 320. The read EDID is packed into a RFID-format signal Srf by the RFID controller 310 and outputted to the RFID reader 312 via the antenna 311.

As shown in FIG. 3B, the monitor 300 can include a plug-in EEPROM 320 and a VGA connector 330 coupled to the EEPROM 320 via an I2C bus 324. The I2C buses 322 and 324 are coupled to the same SCL and SDA pins of the EEPROM 320. Therefore, in manufacturing and maintaining process, manufacturers or service staff can selectively use the RFID reader 312, or use an interface card or a display card coupling to the VGA connector 330 to read/write EDID on the EEPROM 320.

As shown in FIG. 3C, the monitor 300 can also include an embedded EEPROM 320, the VGA connector 330, and a MCU 340. The MCU 340 is coupled to the EEPROM 320 via a first I2C bus 326 and coupled to the VGA connector 330 via a second I2C bus 328. The I2C buses 326 and 322 are coupled to the same SCL and SDA pins of the EEPROM 320. The EEPROM 320 is for storing EDID and monitor data Dm. Therefore, in manufacturing and maintaining process, manufacturers or service staff can selectively use the RFID reader 312 to read/write EDID on the EEPROM 320, or use an interface card or a display card to access EDID on the EEPROM 320 via the VGA connector 330 and the MCU 340.

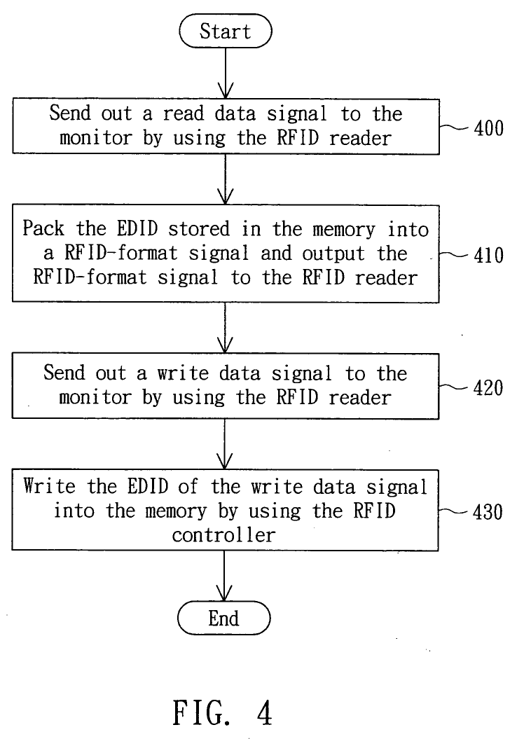

Referring to FIG. 4, a flow chart of an EDID access method according to the preferred embodiment of the invention is shown. First, perform an EDID reading procedure. In step 400, send out a read data signal Sr to the RFID controller 310 by using the RFID reader 312. The read data signal Sr as received by the antenna 311 generates an induced current I for driving the RFID controller 310. The driven RFID controller 310 outputs a driving voltage Vd to drive the EEPROM 320. Next, in step 410, pack the EDID stored in the EEPROM 320 into a RFID-format signal Srf and output the signal Srf to the RFID reader 312. When the RFID controller 310 and the EEPROM 320 are driven, the RFID controller 310 outputs a start signal Start and a read data command Cr to the EEPROM respectively through the SCL line and the SDA line of the I2C bus 322. The EEPROM 320 outputs the EDID to the RFID controller 310 via the SDA line of the I2C bus 322 according to the read data command Cr. The RFID controller 310 further packs the EDID in the RFID-format signal Srf and outputs the signal Srf to the RFID reader 312.

Continuously, perform an EDID writing procedure. In step 420, send out a write data signal Sw packed with EDID to the RFID controller 310 by using the RFID reader 312. The write data signal Sw as received by the antenna 311 generates an induced current I to drive the RFID controller 310. The driven RFID controller 310 then outputs the driving voltage Vd to drive the EEPROM 320. Next, in step 430, the RFID controller 310 writes the EDID of the write data signal Sw into the EEPROM 320. When the RFID controller 310 and the EEPROM 320 are driven, the RFID controller 310 outputs a start signal Start and a write data command Cw to the EEPROM 320 respectively via the SCL line and the SDA line of the I2C bus 322. Then, the RFID controller 310 writes the EDID of the write data signal Sw into the EEPROM 320 via the SDA line of the I2C bus 322 to complete the EDID access process.

As described above, although the monitor 300 is exemplified to have the EEPROM 320 and the RFID controller 310 is exemplified to be coupled to the EEPROM 320 via the I2C bus in the invention, the monitor of the invention can also use other memory to store EDID and the RFID controller 310 can also communicate EDID with the memory by using other transmission method. As long as the EDID can be accessed on the monitor by a wireless method, all these will not depart from the scope of the invention.

The monitor and EDID access method thereof disclosed by the above-mentioned embodiment of the invention has the following advantages:

1. The better EDID transmission quality can be achieved by using the RFID controller to access EDID on the EEPROM in a wireless method.

2. Owing that the RFID controller and the VGA connector use the common I2C pins of the EEPROM, the manufacturers and the service staff can selectively use a wireless device or a VGA cable to access EDID, thereby improving the elasticity of EDID access and effectively reducing the labor requirement in production, servicing and quality control.

3. The monitor of the invention can be applied to a wireless display or a projector to access EDID in a wireless way.

4. The memory of the monitor can store RFID tag files for stock arrangement, thereby save the cost of additionally purchasing RFID tag files.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A monitor, for a radio frequency identification (RFID) reader to access extended display identification data (EDID), the monitor comprising:
a memory, for storing the EDID; and
a RFID control unit, coupled to the memory, for sending the EDID stored in the memory to the RFID reader and storing the EDID sent from the RFID reader into the memory.

2. The monitor according to claim 1, wherein the RFID control unit further comprises an antenna and a RFID controller, and the RFID controller is coupled to the memory.

3. The monitor according to claim 2, wherein the antenna is used to receive a RFID-format signal outputted from the RFID reader for driving the RFID controller to transmit the EDID.

4. The monitor according to claim 2, wherein the RFID controller has a first power pin and the memory has a second power pin coupled to the first power pin for receiving a driving voltage.

5. The monitor according to claim 2, wherein the RFID controller is for retrieving the EDID stored in the memory, and packs the EDID into a RFID-format signal to be outputted by the antenna.

6. The monitor according to claim 1, wherein the RFID control unit is coupled to the memory via an Inter-integrated circuit (I2C) bus for transmitting the EDID.

7. The monitor according to claim 1, further comprising a video graphic array (VGA) connector, coupled to the memory via an I2C bus.

8. The monitor according to claim 1, further comprising a VGA connector and a micro-processing unit (MCU), wherein the MCU is coupled to the memory via a first I2C bus and coupled to the VGA connector via a second I2C bus.

9. The monitor according to claim 8, wherein the memory is for storing monitor data.

10. The monitor according to claim 1, wherein the memory is an electrically erasable programmable read only memory (EERPOM).

11. The monitor according to claim 1, wherein the memory is for storing a RFID tag file.

12. An EDID access method, for a RFID reader to access EDID on a monitor, the monitor comprising a RFID control unit and a memory, the memory is for storing the EDID, the method comprising steps of:
performing an EDID reading procedure, comprising:
sending out a read data signal to the RFID control unit by using the RFID reader; and
packing the EDID stored in the memory into a RFID-format signal and outputting the RFID-format signal to the RFID reader; and
performing an EDID writing procedure, comprising:
sending a write data signal having the EDID to the RFID control unit by using the RFID reader; and
writing the EDID of the write data signal into the memory by using the RFID control unit.

13. The method according to claim 12, wherein the step of sending the read data signal by using he RFID reader further comprises steps of:
driving the RFID control unit by using the read data signal; and
outputting a driving voltage to drive the memory by the RFID control unit.

14. The method according to claim 13, wherein the step of packing the EDID into the RFID-format signal comprises steps of:
outputting the EDID from the memory to the RFID controller via an I2C bus; and
packing the EDID into the RFID-format signal for output by using the RFID controller.

15. The method according to claim 12, wherein the step of sending the write data signal by using the RFID reader further comprises steps of:
driving the RFID control unit by the write data signal; and
outputting a driving voltage to drive the memory by using the RFID control unit.

16. The method according to claim 15, wherein the step of writing the EDID into the memory comprises outputting the EDID packed in the write data signal to the EEPROM via an I2C bus by using the RFID control unit.

17. The method according to claim 12, wherein the memory is an EEPROM.
